(19) United States
(12) Patent Application Publication
(10) Pub. No.: US 2006/0133339 A1
(43) Pub. Date: Jun. 22, 2006

(54) System for collecting, storing, and selectively distributing data

(76) Inventor: Francesca Rosella, Rome (IT)

Correspondence Address: JAMES E. EAKIN, P.O. BOX 1250, MENLO PARK, CA, 94025-4317, US

(21) Appl. No.: 11/286,200

(22) Filed: Nov. 22, 2005

Related U.S. Application Data
(60) Provisional application No. 60/630,063, filed on Nov. 22, 2004.

(51) Int. Cl. H04Q 7/24

(52) U.S. Cl. 370/338

(57) ABSTRACT

The present invention includes a system and mobile device for storing, accessing and sharing information across a network. The system includes a wide area network and a local area network formed on an ad hoc basis by at least two mobile devices. The mobile devices are connectable to the wide-area network to gain access to data stored on a database, while the user settings and the local area network informs the device which information the device should access.

### BACKGROUND OF THE INVENTION

1. Field of the Invention

The present invention relates generally to the field of information storage and dissemination, and more specifically relates to the field of creating and maintaining wireless local area networks for sharing personal or other information.

2. Description of the Prior Art

People love to browse the Internet and gather information about what is happening with people they know and don't know, all over the world. And the recent growing popularity of websites for creating friendship networks signals that people are extremely willing to use the new technology to create social networks and connections. The Internet is filled with information about individuals and companies. An individual may have personal, business, medical and financial information stored or storable on a database that is accessible through a networked computer. For example, many people have home computers on which they store this type of information.

Some of this information is made available to the public on ad hoc networks of the type described above. Web-based personals, online weblogs, company profiles and professional resumes are easily accessed by anyone with a familiarity with Internet browsing. All of this information is provided at the discretion of the individual or company in question, and can usually be shared or changed on a whim. Nevertheless, for the inquiring individual, this information is generally only accessible through the Internet, which may require a computer affixed to a wide area network. The lack of mobility in this scheme does not allow for the widespread dissemination and sharing of information that may be valuable, for personal, business or other reasons, to the extent the owner of the information is willing to share such access.

Therefore, there is a need in the art for a system that allows a user to wirelessly access his or her personal information and transmit that information across an ad hoc local area network to other users of interest. Such a system would ideally provide a number of mechanisms through which this networking could take place. Furthermore, such a system would preferably be highly portable and independent of, or compatible with, any established communications protocols found on the more ubiquitous Internet.

### SUMMARY OF THE INVENTION

Accordingly, the present invention consists of a mobile information device, a controller that manipulates and exchanges data, and a corresponding database for storing data. It will be appreciated that the database may be comprised of one or more databases, some or all of which may be distributed across different servers or locations. The device of the present invention has the ability to connect to the Internet (or other a wide-area network). The device also has the ability to create and connect to ad-hoc local-area networks, such as for example those established through radio frequency, infrared, Bluetooth, or other local network technology or protocol. The device connects to these local-area networks through internal hardware or external accessory hardware. For example, the device can, in some embodiments, be a mobile telephone or personal digital assistant that contains the necessary antenna or transmission system. In an alternate embodiment, the device can be connected to an external antenna that is embedded or selectively placed in a user's clothing. In either embodiment, the device includes appropriate software or firmware for managing the accessing and distribution of the approved data.

The controller is adapted to poll specific, predefined databases on the wide-area network for changes to the data. What data it polls is based on user-defined preferences. These databases are constructed and formatted in the necessary manner for access by the controller of the mobile device. The database can be arranged in any suitable manner, and may for example be arranged to provide access to approved personal, financial, medical, relational, emotional, or cultural information. For each such category, further organization may be provided, for example for the category ‘culture’ a subcategory might be books or music the user listens to. The data can be collected, shared, or accessed to permit a user to share data one to one with another user, or with many other users of the system. On a broader level of example, a cinema which interoperates with the system can share with potential customers the price of a ticket, movie start times, and so on. In another aspect of the invention, the user can receive this information upon approaching the building, and, upon entering the building indicate acceptance of the pricing information and authorize, in return, sharing of charging or credit card information. The server managing the building's information may then accept the user's charging information, at which point a ticket is purchased, via the system of the present invention, by directly accessing the bank account of the user or other charging information of the user. In some embodiments, the financial institution, e.g, a bank sends back to the user a report of the transaction. In this manner, entire transactions may be automated to permit users to move freely without waiting in lines or other time-consuming and generally unpleasant experiences.

When meeting other users, the first user database is updated with the new information, for example in the category relational the user might find the name of the new friend that he or she just met, if the other person allowed this information to be accessible. The controller is adapted to simultaneously use the necessary hardware for connecting to a local area network (via, for example, Bluetooth or other wireless protocol), and to seek other users of similar hardware or other entities (like buildings or businesses) that are also participating in the system. It will be appreciated that the use of appropriate filters and approvals will be desired for most embodiments to ensure reasonable privacy for the users.

All of the data that is shared among users on the system of the present invention is accessible and transmittable based upon the established settings of the respective parties. Senders may, through selection of appropriate settings, identify the data they are willing to share. Recipients may also restrict the acceptance of incoming data from other users based upon acceptance criterion established in the settings. Thus, in accordance with at least an embodiment of the present invention, the transfer of information between a particular sender and a particular recipient is limited to only that information which the sender is willing to send, and the recipient is willing to receive. Accordingly, the present invention includes at least settings for the accessibility, transmission and receipt of information. As one example, a couple meeting casually in a social environment may impose strict limits on the type of information about themselves that they are willing to share with the rest of the gathering, but may modify those limits for a person they find of particular interest.

The present invention further provides multiple avenues through which data may be shared among users. In one embodiment, the data can be transmitted through the local area network directly through mobile devices that are part of the local area network. The local sharing embodiment is particularly useful if the wide-area network is not immediately available to the user seeking to transmit the information. In an alternative embodiment, the users can exchange data pointers across the local area network. The data pointers allow the users to access the appropriate information from the database on the larger wide-area network. In either of the noted embodiments, the user has the same seamless experience as the data arrives on their system in the same manner. Further details and preferred embodiments of the present invention are described in detail below with reference to the following drawings.

### BRIEF DESCRIPTION OF THE DRAWINGS

FIG. 1 is a schematic block diagram of a network system according to the invention which includes a database, together with a plurality of the devices of the present invention configured to operate across a network which may include a wide area and a local area network.

FIG. 2 is a schematic block diagram detailing the interaction of the respective networks of the present invention.

FIG. 3 is a schematic block diagram of the system of the present invention showing the interaction between a pair of mobile devices forming part of the network.

FIG. 4 is a schematic block diagram of an alternate embodiment of the system of the present invention.

### DETAILED DESCRIPTION OF THE INVENTION

Referring now to the Figures, the present invention is described in greater detail with reference to particular preferred embodiments. As shown below, the system and device of the present invention provide for the creation of ad hoc local area networks for the sharing of data. The data can be retrieved from a database on a wide area network, another device on the WAN, or from one of the devices attached to the local area network.

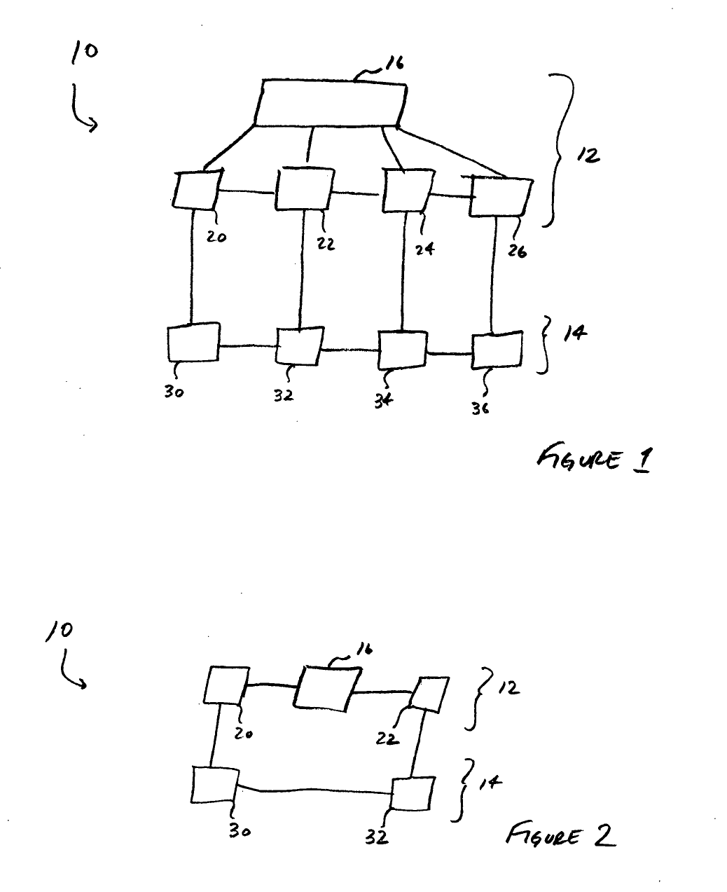

In particular, FIG. 1 is a schematic block diagram of the system 10 of the present invention. The system 10 includes a wide area network (WAN) 12 and a local area network (LAN) 14. In one embodiment, the WAN 12 may include a connection to one or more databases 16, each of which is adapted for the inputting, organization, storage and retrieval of data. As previously noted, the data can be of any sort that an individual might want to selectively share with another user of the system 10. Personal history, preferences, and medical information information are examples of data that may be useful in the system 10, although any type of data suitable for a database may be stored on the database 16.

The WAN 12 further includes a first controller 20 and a plurality of other controllers 22, 24, 26 that are connected to the database and each other. This type of connecting system is known in the art as a network, and the most relevant approximation of the WAN 12 of the present invention is the existing network known as the Internet. Thus, for example, the first controller 20 might be a server or personal computer that is connected or connectable to a wide area network of other servers or personal computers, such as those depicted as controllers 22, 24, 26. Moreover, each of the individual controllers 22, 24, 26 and the first controller 20 are independently connected or connectable to the database 16, which in itself may be another server for storing data uploaded by the respective controllers.

The system 10 of the present invention also includes the LAN 14, which is a local network that may be created on an ad hoc basis, preferably through wireless connections and data transfers. The LAN 14 includes a first mobile device 30 and at least a second mobile device 32. A plurality of additional mobile devices 34, 36 are also shown to emphasize that the LAN 14 may include any number of member mobile devices. In a preferred embodiment, the first mobile device 30 and the second mobile device 32 are of the type known in the art of wireless communications. For example, mobile telephones, personal digital assistants and other emerging technologies are all capable of forming ad hoc data networks on a local basis for the transfer of data. The first mobile device 30 and the second mobile device 32 are therefore defined as being of this type of communications device. In another preferred embodiment, the second mobile device 32 is a communications device that is specifically related to a building, business, or governmental establishment. For example, the second device 32 could be a communications device that is part of an interactive museum exhibit, part of a hospital waiting room, or within the lobby of a large business facility. Thus, the second mobile device 32 should not be limited to devices that are, mobile, handheld or worn on the body. In a preferred embodiment the system is mobile or wearable, however for buildings or other parties using the system the device could be a database able to connect to the WAN and LAN through the available wired or wireless protocols.

Referring now to FIG. 2, the interaction between the WAN 12 and the LAN 14 is shown in greater detail. The first controller 20 is in communication with the database 16, as is controller 22. The first controller 20 is preferably connected to the database 16 on an “as needed” basis such as the connection established between a personal computer and a server through normal Internet Protocol interactions. The first controller 20 may upload, download, send and retrieve data from the database 16 at the discretion of the user. This data can be wirelessly transmitted to the first mobile device 30. Similarly, the data retrieved by controller 22 can be wirelessly transmitted to the second mobile device 32.

The first mobile device 30 and the second mobile device 32 are adapted to actively poll other mobile devices within their respective wireless ranges for possible LAN 14 connections. For example, the first mobile device 30 is adapted to provide a wireless signal that will query for other mobile devices, such as the one represented by the second mobile device 32. Upon receipt of the query signal, the second mobile device 32 can respond to the first mobile device 30 thereby forming the LAN 14. Once the LAN 14 is established, the respective users of the first mobile device 30 and the second mobile device 32 can exchange data that was originally stored on the database 16.

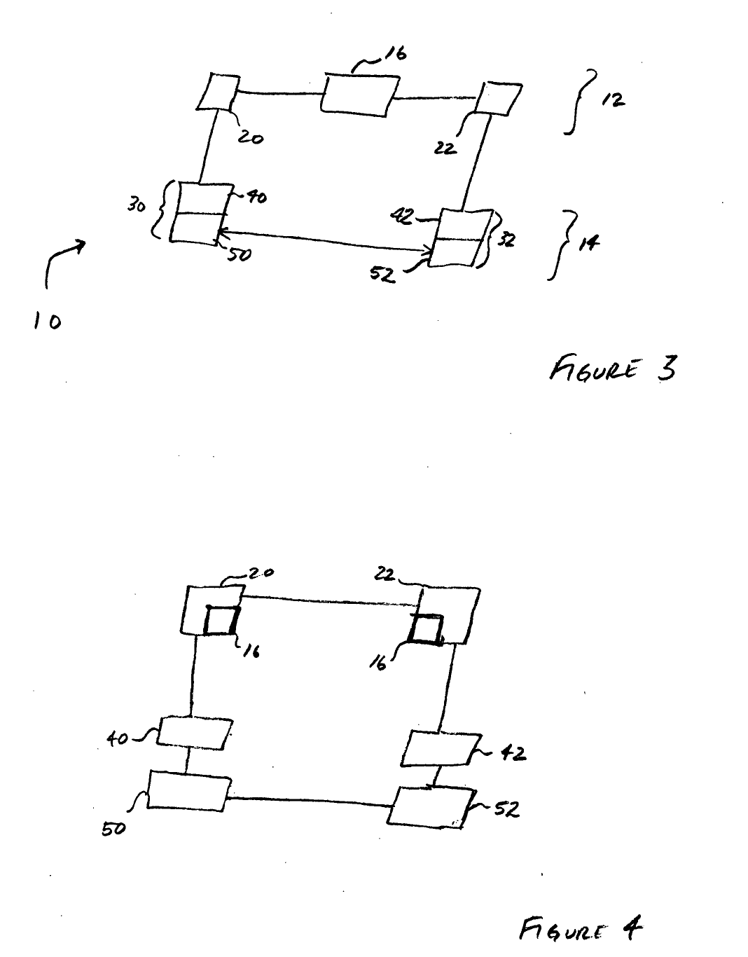

FIG. 3 is another schematic block diagram of an alternate configuration of the system 10 of the present invention. In FIG. 3, it is shown that the first mobile device 30 and the second mobile device 32 form the LAN 14. The first mobile device 30 includes a first processor 40 and a first communications means 50, such as an, IR transceiver, Bluetooth transceiver, or other suitable wireless communications apparatus. The second mobile device 32 includes a second processor 42 and a second communications means 52, which may also comprise an IR transceiver, Bluetooth transceiver, or other suitable wireless communications apparatus. The LAN 14 is formed by the communication between the first communications means 50 and the second communications means 52. The first communications means 50 and the second communications means 52 are directly coupled to their respective processors 40, 42, as shown in FIG. 3.

In this embodiment, the first mobile device 30 and the second mobile device 32 have their respective communications and processing apparatus associated in the same space. This configuration is readily adaptable to mobile telephones, personal digital assistants and the next generation of portable electronic devices that have sufficient communications and processing capacity to form an ad hoc LAN 14 as described herein. It will also be appreciated that the commands necessary for using the system of the present invention may be implemented as voice commands, to avoid the necessity of keying in information, or may be visual commands; the particular nature of the human interface may be any type suited to ensuring accurate communication of the user's intent to the servers so that only approved information is disseminated.

In an alternate embodiment of the present invention shown in FIG. 4, the WAN 12 includes only the first controller 20 and a second controller 22. The database 16 formerly shown as a standalone server is now integrated into each of the first controller 20 and the second controller 22, and may be configured as one or more databases. In this embodiment, it is understood that the term database 16 should be understood to mean a set of data, such as that stored on a user's personal computer, which may be represented by first controller 20. For example, the first controller 20 may be a user's personal computer and the database 16 is a set of data stored on the first controller 20, which may be selectively accessed or shared across the WAN 12 as is typically done on the Internet today.

In FIG. 4 the LAN 14 includes the first mobile device 30 and the second mobile device 32. In this embodiment, however, the first processor 40 is distally located from the first communications means 50. Similarly, the second processor 42 is distally located from the second communications means 52. As before, the first communications means 50 and the second communications means 52 are in wireless communication with each other forming the LAN 14. In this embodiment, the first communications means 50 is also in communication, preferably wireless communication, with the first processor 40 as well as the first controller 20. It will be appreciated that, in an environment of the future, the database associated with user will comprise, in essence, a wearable identity, and may be implemented in either a next generation cell phone or other wearable communications device.

Accordingly, the first communications means 50 may be a stand-alone antenna, IR transceiver, Bluetooth transceiver or similarly configured apparatus for sending and receiving wireless signals. The first communications means 50 is adapted for simultaneous communication and data transfer between across the LAN 14 as well as between itself and the first processor 40 and the first controller 20.

It will be appreciated that the first communications means 50 is not required to be in wired communication with the first processor 40. As such, the first communications means 50 may be located or placed in any number of creative fashions. For example, the first communications means 50 could be embedded in a user's clothing or selectively attached thereto. The first communications means 50 could take the shape of any accessory or peripheral device that is customarily worn or displayed by potential users, such as jewelry, watches, shoes and the like. As the first communications means 50 is not physically attached to the first processor 40, which may be of any suitable type, and may for example be a mobile phone or as complex as a server, the only limitations on its form or disposition are the creativity of users and designers.

Given the foregoing, it is readily apparent that the system and mobile device of the present invention is well suited for the discretionary and reliable transfer of personal data between potential users. In particular, the system of the present invention includes a local area network that can be formed on an ad hoc basis by multiple mobile devices. The mobile device can be decentralized such that the wireless communications device can take the form of a wearable or removable accessory separate and apart from the processing or computational means. The foregoing is intended as a description of the preferred embodiments of the present invention, and it should be understood that many modifications and substitutions can be made by those skilled in the art without departing from the scope of the present invention as defined in the following claims.

I claim:

1. A system for storing, selecting, and sharing data, the system comprising:
a database including data, the database connectable to a wide area network;
a first mobile device connectable to the database and adapted for the wireless creation of a local area network; and
a second mobile device wirelessly connectable to the first mobile device and the database, the second mobile device adapted for the wireless creation of a local area network including at least the first mobile device.

2. The system of claim 1 further comprising a first controller wirelessly connectable to the first mobile device, the first controller forming part of the wide area network.

3. The system of claim 1 wherein the first mobile device includes a first processor and a first communications means.
